(19) United States
(12) Patent Application Publication
(10) Pub. No.: US 2014/0182425 A1
(43) Pub. Date: Jul. 3, 2014

(54) Hand Tool

(71) Applicants: YU-CHING KUO, TAICHUNG CITY (TW); YI-CHING YU, TAICHUNG CITY (TW)

(72) Inventors: YU-CHING KUO, TAICHUNG CITY (TW); YI-CHING YU, TAICHUNG CITY (TW)

(21) Appl. No.: 13/854,059

(22) Filed: Mar. 30, 2013

(30) Foreign Application Priority Data
Dec. 27, 2012 (TW) 101225247

(51) Int. Cl. B25G 1/10

(52) U.S. Cl. CPC B25G 1/10
USPC 81/489

(57) ABSTRACT

The invention proposes a hand tool comprising a handle, at least one operating portion, an elastic layer and a protective layer. The handle is a region for a user to hold and apply force. The at least one operating portion connected with the handle has different shapes based on different elements engaged with. The elastic layer set on at least a part of surface of the hand tool is used to absorb vibration and acting force when using the hand tool. The protective layer set on the elastic layer is flexible and contractible and therefore prevents components of the hand tool from loosening and being abraded. The protective layer is further provided with a texture surface comprising a convex surface and a concave surface to increase friction.

### BACKGROUND OF THE INVENTION

1. Field of the Invention

This present invention relates to a hand tool, more particularly to a hand tool with functions of vibration proof, durable abrasion, non-slipping and insulation.

2. Description of the Related Prior Art

A hand tool is a tool for a user to hold and apply force to accomplish various purposes, such as fixation or disassembly. When using a conventional hand tool with a handle covered with hard material, vibration and acting force are easily generated and further transmit to a hand holding the conventional hand tool. During usage of the conventional hand tool, a sore hand or perspiration in a palm is likely to happen and further makes the user unable to effectively apply force or even harms the hand for inappropriately applying force. Moreover, the conventional hand tool is usually made of a metal of a good electrical conductor; therefore, electric shock is likely to happen during an electricity-related task for inadvertent contact with a conducting part.

The conventional hand tool is provided with multiple sorts of fastenings to match various elements, for instance, a flathead-form screwdriver matches a flathead-form screw, or a tetragonal wrench matches a tetragonal bolt. The conventional hand tool is further provided with a position of a convex part, a concave part or a turning part and different components which may loosen or be abraded because of long-term usage making the user unable to effectively apply force or even harming the hand because of loosening of the conventional hand tool.

### SUMMARY OF THE INVENTION

The invention proposes a hand tool to improve defects caused by a conventional hand tool stated in the Related Prior Art.

The hand tool comprises a handle for a user to hold and apply force, at least one operating portion connected with the handle, an elastic layer set on at least a part of surface of the hand tool, and a protective layer set on the elastic layer and tightly connected with the elastic layer. The at least one operating portion is provided with various shapes in order to engage with different elements so that the user may apply force to the elements through the hand tool. The elastic layer is used to absorb vibration and acting force and to increase comfort when using the hand tool. Suppose the hand tool should drop leading components to loosen or detach and fall on a human body, the elastic layer would be a buffer to reduce an injury to the human body. The protective layer is insulating, flexible and contractible and therefore prevents the components of the hand tool from loosening and being abraded. The protective layer is further provided with a texture surface with different textile touches comprising a convex surface and a concave surface to increase friction.

The invention has a number of advantages. The elastic layer set on the hand tool is used to absorb the vibration and the acting force and to increase the comfort when using the hand tool. Suppose the hand tool should drop leading the components to loosen or detach and fall on the human body, the elastic layer would be the buffer to reduce the injury to the human body. Besides reinforcing vibration absorption and the comfort of the hand tool, the protective layer is tightly set on the elastic layer so that the components may not loosen and be abraded; also, the protective layer has a feature of insulation which can protect the user from electric shock during an electricity-related task. The protective layer is further provided with a texture surface with different textile touches comprising a convex surface and a concave surface to increase the friction which may help the user apply force and improve convenience in using the hand tool.

### BRIEF DESCRIPTION OF THE DRAWINGS

FIG. 1(a) is a schematic drawing of one preferable embodiment of the present invention.

FIG. 1(b) is a structural drawing of one preferable embodiment of the present invention.

FIG. 2 is a schematic drawing of another preferable embodiment of the present invention.

FIG. 3(a) is a schematic drawing of another preferable embodiment of the present invention.

FIG. 3(b) is another schematic drawing of another preferable embodiment of the present invention.

FIG. 4(a) illustrates at least one operating portion in one preferable embodiment of the present invention.

FIG. 4(b) illustrates the at least one operating portion in one preferable embodiment of the present invention.

FIG. 5(a) illustrates the at least one operating portion in another preferable embodiment of the present invention.

FIG. 5(b) illustrates the at least one operating portion in another preferable embodiment of the present invention.

FIG. 6(a) illustrates the at least one operating portion in another preferable embodiment of the present invention.

FIG. 6(b) illustrates the at least one operating portion in another preferable embodiment of the present invention.

FIG. 7 is a schematic drawing of another preferable embodiment of the present invention.

FIG. 8 is a schematic drawing of another preferable embodiment of the present invention.

### DETAILED DESCRIPTION OF THE INVENTION

Hereinafter, embodiments of the invention will be explained in detail with reference to the drawings; however, the invention is not limited thereto.

### One Preferable Embodiment

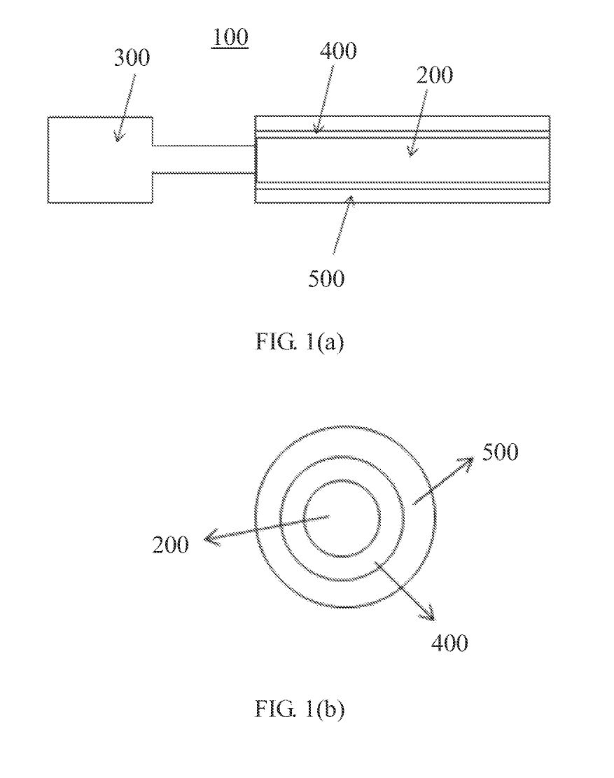

Refer to FIG. 1(a). A hand tool 100 comprises a handle 200, at least one operating portion 300, an elastic layer 400 and a protective layer 500. The handle 200 is a region for a user to hold and apply force. To tightly engage with an element which can be different shapes, the at least one operating portion 300 connected with the handle 200 has different shapes and components comprising a protrudent flathead-form, a protrudent cruciform, a protrudent tetragon, a protrudent pentagon, a protrudent hexagon, or a hollow tetragon, a hollow pentagon, a hollow hexagon, a hollow dodecagon. The element can be a flathead-form screw, a cruciform screw, a tetragonal screw, a pentagonal screw, a hexagonal screw, a tetragonal bolt, a pentagonal bolt, a hexagonal bolt, a dodecagonal bolt, a nail or a rivet. The user can easily apply force to the element through the hand tool 100 on account that the at least one operating portion 300 can engage with the element which can be different shapes. The elastic layer 400 is set on at least a part of surface of the hand tool 100 as shown in FIG. 1(b). The elastic layer 400 made from polystyrene, polyethylene, polyurethane, polyvinyl chloride or polypropylene is used to absorb vibration and acting force when using the hand tool 100 for the user to feel comfortable in prolonged usage and protecting a human body against an injury in case of the hand tool 100 dropping. The protective layer 500 set on and connected with the elastic layer 400 as shown in FIG. 1(b) is made from polyolefin which is flexible and contractible. The elastic layer 400 and the protective layer 500 can be set on the handle 200, the at least one operating portion 300, a convex part 600 of the hand tool 100, a concave part 700 of the hand tool 100, or a turning part 800 of the hand tool 100. In One Preferable Embodiment, the protective layer 500 is set on the elastic layer 400 set on the handle 200. Besides reinforcing vibration absorption and eliminating the acting force, the protective layer 500 tightly set on the elastic layer 400 can prevent the components from loosening and being abraded; also, the protective layer 500 has a feature of insulation which can protect the user from electric shock during an electricity-related task.

### Another Preferable Embodiment

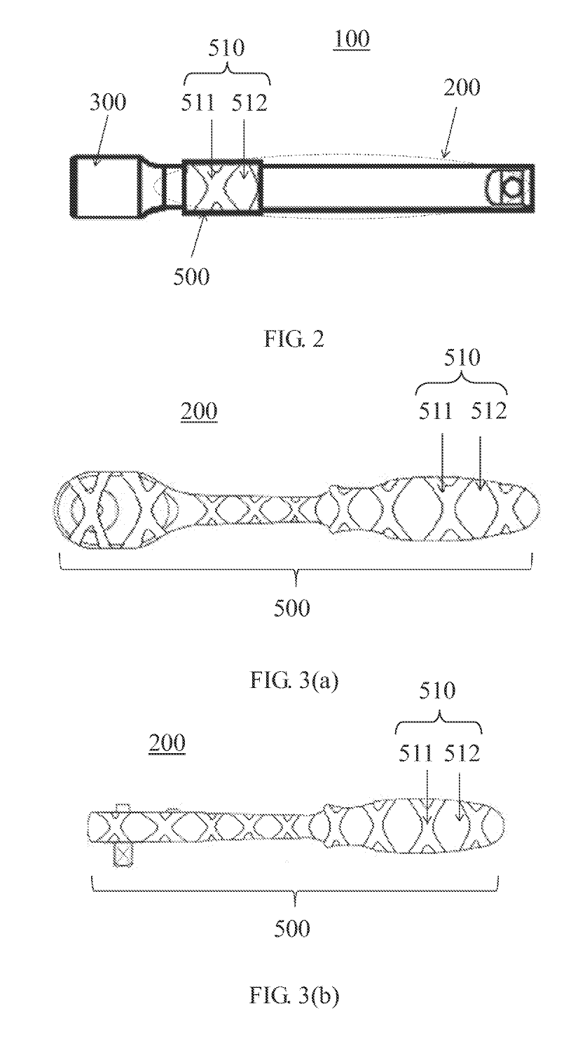

Refer to FIG. 2. The protective layer 500 set on the handle 200 near the at least one operating portion 300 is a position for user's fingers to grip when the user is holding the hand tool 100. The elastic layer 400 is set on the protective layer 500 and therefore absorbs the vibration and the acting force when using the hand tool 100. The protective layer 500 is further provided with a texture surface 510 with different textile touches comprising at least one convex surface 511 and at least one concave surface 512. The at least one convex surface 511 and the at least one concave surface 512 of the texture surface 510 are provided with non-slip nap for a better non-slipping effect.

### Another Preferable Embodiment

FIGS. 3(a) and 3(b) are schematic drawings of the handle 200 of Another

Preferable Embodiment of the present invention. The handle 200 can be connected with the at least one operating portion 300 which has multiple sorts. The elastic layer 400 and the protective layer 500 are set on and cover the handle 200. The elastic layer 400 can absorb the vibration and the acting force when using the hand tool 100, and the protective layer 500 can reinforce effectiveness of the elastic layer 400 and prevent the components from loosening and being abraded because the protective layer 500 tightly covers the handle 200 as a whole. The elastic layer 400 and the protective layer 500 further cover a joint of the handle 200 and the at least one operating portion 300 so that the components can be less abraded when used in combination. The protective layer 500 is provided with the texture surface 510 with different textile touches comprising the at least one convex surface 511 and the at least one concave surface 512. The at least one convex surface 511 and the at least one concave surface 512 of the texture surface 510 are provided with the non-slip nap for the better non-slipping effect helping the user properly apply force to the hand tool 100.

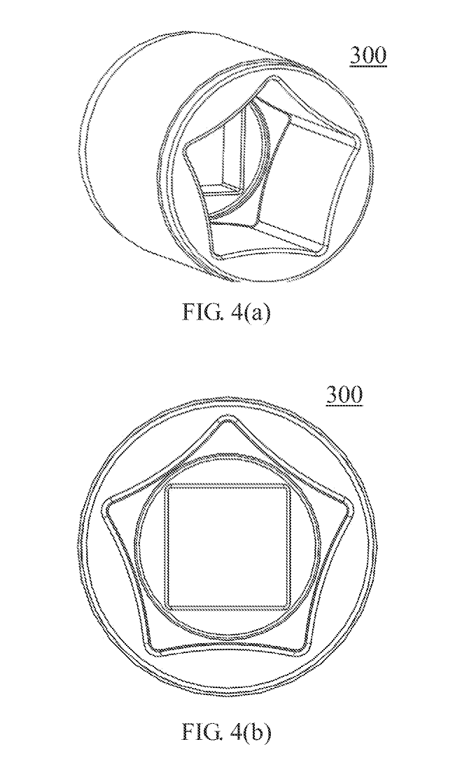

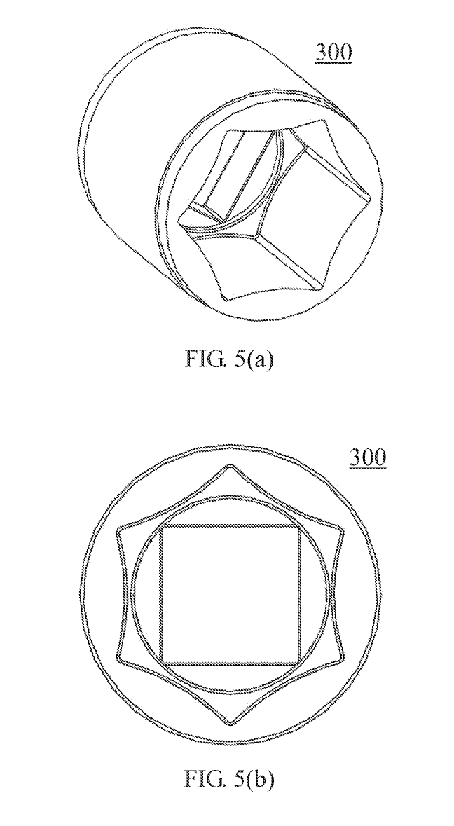

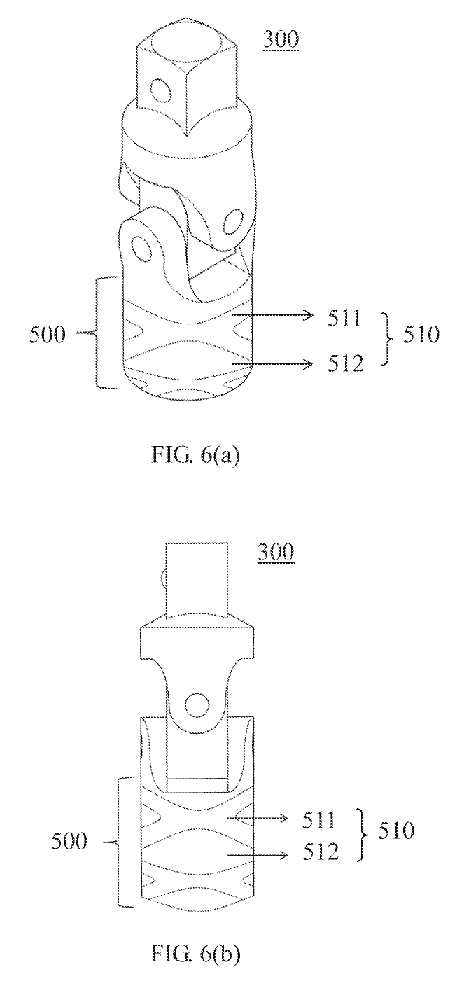

FIGS. 4(a), 4(b), 5(a) and 5(b) illustrate embodiments of the at least one operating portion 300 which can be connected with the handle 200 in FIGS. 3(a) and 3(b) to become the hand tool 100. FIGS. 4(a) and 4(b) illustrate the One Preferable Embodiment of the at least one operating portion 300 which is a hollow pentagon engaging with a pentagonal bolt. FIGS. 5(a) and 5(b) illustrate the Another Preferable Embodiment of the at least one operating portion 300 which is a hollow hexagon engaging with a hexagonal bolt. FIGS. 6(a) and 6(b) illustrate the Another Preferable Embodiment of the at least one operating portion 300 which can be connected with the handle 200 and rotated at will. The elastic layer 400 and the protective layer 500 absorbing the vibration and the acting force can be set on the at least one operating portion 300 so that abrasion cause by engagement of the at least one operating portion 300 and the element and the electric shock cause by inadvertent contact can be prevented.

### Another Preferable Embodiment

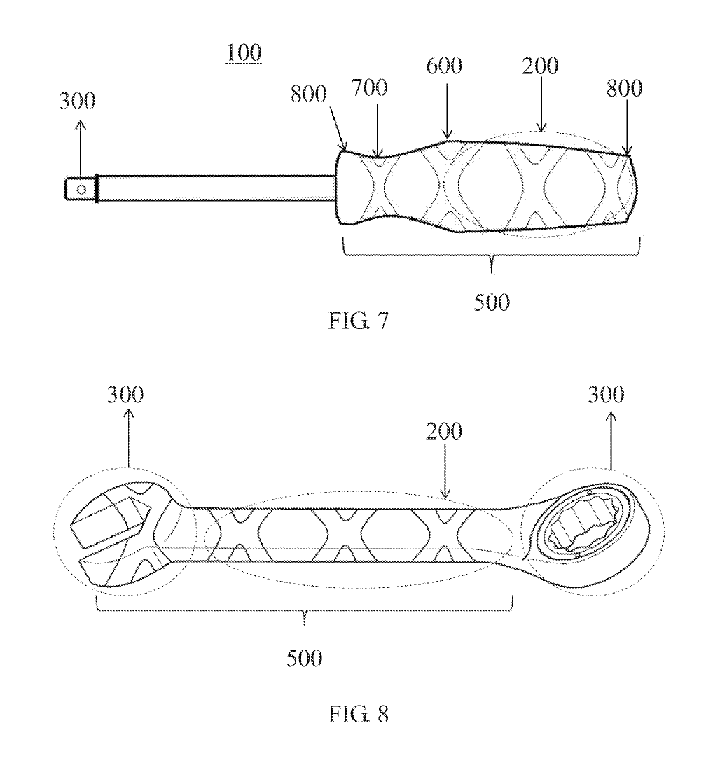

Refer to FIG. 7. The elastic layer 400 and the protective layer 500 absorbing the vibration or the acting force when using the hand tool 100 and preventing the user from the injury can be set on the convex part 600 of the hand tool 100, the concave part 700 of the hand tool 100 and the turning part 800 of the hand tool 100 which are parts that are likely to be abraded or injure the user.

### Another Preferable Embodiment

Refer to FIG. 8. The hand tool 100 comprises two at least one operating portion 300 tightly covered by the elastic layer 400 and the protective layer 500 as a whole which can absorb the vibration and the acting force, prevent the components from loosening and being abraded and further improve safety when using the hand tool 100.

What is claimed is:

1. A hand tool comprises:
a handle;
at least one operating portion connected with the handle and able to connect an element;
an elastic layer connected with at least a part of surface of the hand tool; and
a protective layer set on the elastic layer and tightly connected with the elastic layer.

2. The hand tool as claimed in claim 1, wherein a shape of the at least one operating portion is a protrudent flathead-form, a protrudent cruciform, a protrudent tetragon, a protrudent pentagon, a protrudent hexagon or a shape engaging with the element.

3. The hand tool as claimed in claim 1, wherein the shape of the at least one operating portion is a hollow tetragon, a hollow pentagon, a hollow hexagon, a hollow dodecagon or the shape engaging with the element.

4. The hand tool as claimed in claim 1, wherein the element is a flathead-form screw, a cruciform screw, a tetragonal screw, a pentagonal screw, a hexagonal screw, a tetragonal bolt, a pentagonal bolt, a hexagonal bolt, a dodecagonal bolt, a nail or a rivet.

5. The hand tool as claimed in claim 1, wherein the protective layer is further provided with a texture surface with different textile touches comprising convex surfaces and concave surfaces.

6. The hand tool as claimed in claim 5, wherein the convex surfaces of the texture surface are provided with non-slip nap.

7. The hand tool as claimed in claim 5, wherein the concave surfaces of the texture surface are provided with the non-slip nap.

8. The hand tool as claimed in claim 1, wherein material of the protective layer is polyolefin.

9. The hand tool as claimed in claim 1, wherein a position of the protective layer is set on the handle, the at least one operating portion, a convex part of the hand tool, a concave part of the hand tool or a turning part of the hand tool.

10. The hand tool as claimed in claim 1, wherein a position of the elastic layer is set on the handle, the at least one operating portion, the convex part of the hand tool, the concave part of the hand tool or the turning part of the hand tool.

11. The hand tool as claimed in claim 1, wherein material of the elastic layer is polystyrene, polyethylene, polyurethane, polyvinyl chloride or polypropylene.
